(19) United States
(12) Patent Application Publication
(10) Pub. No.: US 2018/0331609 A1
(43) Pub. Date: Nov. 15, 2018

(54) HIGH EFFICIENCY ELECTROMAGNETIC VIBRATION ENERGY HARVESTER

(71) Applicant: ELECTRONICS AND TELECOMMUNICATIONS RESEARCH INSTITUTE, Daejeon (KR)

(72) Inventors: Won Kyu CHOI, Daejeon (KR); Hyun Seok KIM, Jeonju-si (KR); Sang Hyun MO, Daejeon (KR); Chan Won PARK, Daejeon (KR); Kyu Won HAN, Daejeon (KR)

(21) Appl. No.: 15/867,153

(22) Filed: Jan. 10, 2018

(30) Foreign Application Priority Data
May 12, 2017 (KR) 10-2017-0059299

(51) Int. Cl. H02K 35/02; H02K 1/06; H02J 5/00

(52) U.S. Cl. CPC H02K 35/02; H02J 5/00; H02K 1/06

(57) ABSTRACT

An energy harvester includes a first core vibrating in a predetermined direction; a second core being U-shaped and having opposite ends facing at least a part of the first core; a pair of magnetic bodies forming a magnetic flux connected between the first core and the second core; and a coil member wound on the second core to generate an induced current due to a magnetic flux change in the second core.

### CROSS-REFERENCE TO RELATED APPLICATION

The present application claims priority to Korean Patent Application No. 10-2017-0059299, filed May 12, 2017, the entire content of which is incorporated herein for all purposes by this reference.

### BACKGROUND OF THE INVENTION

### 1. Field of the Invention

The present invention relates generally to an energy harvester and, more particularly, to an energy harvester for converting vibration energy into electric energy.

### 2. Description of Related Art

Energy harvesting technology is a technology that can convert kinetic energy or heat/light energy that may be inadvertently wasted in daily life into effective electric energy. The energy harvesting technology has recently been attracting interest as mobile communication terminal technology, wireless sensor network technology, and Internet of Thing (IoT) technology are actively being developed. In addition, since no environmental pollutants are generated during the energy conversion process, much research is being conducted into eco-friendly energy technology.

In particular, research is being conducted on techniques for converting vibration energy into electric energy.

### SUMMARY OF THE INVENTION

Methods for converting vibration energy into electric energy include an electrostatic method, an electromagnetic method, a piezoelectric method, and the like.

The electromagnetic method is a method of generating electric energy induced by permanent magnets and coils. An energy conversion technology based on the electromagnetic method has a characteristic that energy conversion efficiency is drastically lowered when amplitude or acceleration of a vibration frequency generated in a surrounding environment is low.

Due to such a characteristic, the energy conversion technology based on the electromagnetic method cannot be used universally in daily life, and it can be used only in a limited field.

The energy conversion technology based on the electromagnetic method needs high efficiency with high energy conversion characteristics in order to be used in various applications because the smaller a momentum of a vibrating object, the lower an output power.

The technical object of the present disclosure is to provide a high efficiency vibration/electric energy harvester that may be used for general purposes.

Another object of the present invention is to provide a vibration/electric energy harvester capable of realizing high energy conversion characteristics by using a physical vibration source having small momentum.

The technical objects to be achieved by the present disclosure are not limited to the technical matters mentioned above, and other technical subjects that are not mentioned are to be clearly understood by those skilled in the art from the following description.

According to an aspect of the present disclosure, an energy harvester may be provided. The energy harvester includes a first core vibrating in a predetermined direction; a second core being U-shaped and having opposite ends facing at least a part of the first core; a pair of magnetic bodies forming a magnetic flux connected between the first core and the second core; and a coil member wound on the second core to generate an induced current due to a magnetic flux change in the second core.

According to other aspect of the present disclosure, an energy harvester may be provided. The energy harvester includes a first core and a second core vibrating in a predetermined direction within areas different from each other; a third core being U-shaped and having opposite ends facing at least a part of the first core; a fourth core being U-shaped and having a bottom thereof contacting a bottom of the third core and opposite ends facing at least a part of the second core; a pair of first magnetic bodies forming a magnetic flux connected between the first core and the third core; a pair of second magnetic bodies forming a magnetic flux connected between the second core and the fourth core; and a coil member wound on the third core and the fourth core to generate an induced current due to a magnetic flux change in the third core and the fourth core.

The features briefly summarized above for this disclosure are only exemplary aspects of the detailed description of the disclosure which follow, and are not intended to limit the scope of the disclosure.

According to the present disclosure, it is possible to provide a high efficiency vibrationlelectric energy harvester that may be used for general purposes.

Further, according to the present disclosure, a vibrationlelectric energy harvester capable of realizing a high energy conversion characteristic using a physical vibration source having a small momentum may be provided.

The effects obtainable in the present disclosure are not limited to the effects mentioned above, and other effects not mentioned can be clearly understood by those skilled in the art from the description described below.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating a basic energy conversion mechanism of an energy harvester according to an embodiment of the present disclosure;

FIG. 2 is a diagram illustrating characteristics of a voltage and a current output from a coil member included in the energy harvester of FIG. 1;

FIG. 3 is a diagram illustrating a configuration of an energy harvester according to another embodiment of the present disclosure;

FIG. 4 is a diagram illustrating characteristics of a voltage and a current induced in a coil member included in the energy harvester of FIG. 3;

FIG. 5 is a diagram illustrating a configuration of an energy harvester according to an embodiment of the present disclosure; and

FIG. 6 is a diagram illustrating a configuration of an energy harvester according to another embodiment of the present disclosure.

### DETAILED DESCRIPTION OF THE INVENTION

Hereinbelow, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “connected” to another element, it is understood to include not only a direct connection relationship but also an indirect connection relationship. Also, when an element is referred to as “containing” or “having” another element, it means not only excluding another element but also further including another element.

In the present disclosure, the terms first, second, and so on are used only for the purpose of distinguishing one element from another, and do not limit the order or importance of the elements unless specifically mentioned. Thus, within the scope of this disclosure, the first component in an embodiment may be referred to as a second component in another embodiment, and similarly a second component in an embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in an embodiment are also included within the scope of this disclosure. Also, embodiments that include other components in addition to the components described in the various embodiments are also included in the scope of the present disclosure.

Hereinafter, embodiments of the present disclosure will be described with reference to the accompanying drawings.

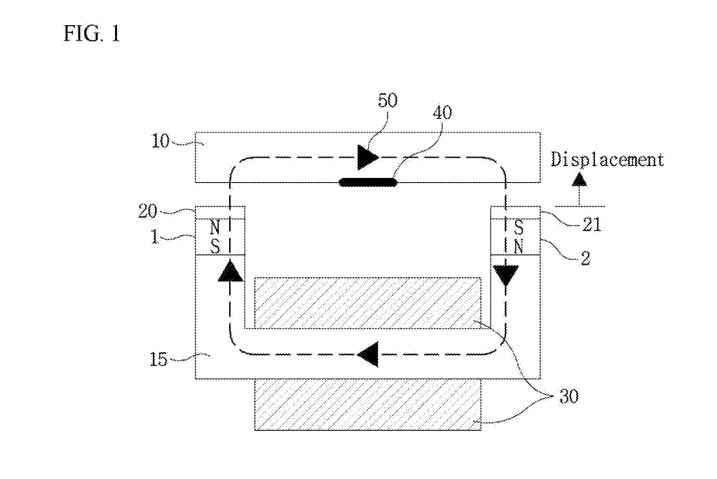

FIG. 1 is a diagram illustrating a basic energy conversion mechanism of an energy harvester according to an embodiment of the present disclosure.

The energy harvester includes an I-shaped magnetic core 10, a U-shaped magnetic core 15, a pair of magnetic bodies 1 and 2, and a coil member 30.

The I-shaped magnetic core 10 and the U-shaped magnetic core 15 may be made of soft ferrite materials.

The I-shaped magnetic core 10 and the U-shaped magnetic core 15 may provide a path through which magnetic flux generated by the magnetic bodies 1 and 2 may be connected. Accordingly, the magnetic bodies 1 and 2 may be provided at opposite ends of the U-shaped magnetic core 15, respectively. In addition, the opposite ends of the U-shaped magnetic core 15 may be provided to face at least a part of the I-shaped magnetic core 10.

The pair of magnetic bodies 1 and 2 may include, for example, permanent magnets having an N pole and an S pole. The pair of magnetic bodies 1 and 2 may include a first magnetic body 1 provided at one end of the magnetic core 15 and a second magnetic body 2 provided at the other end of the magnetic core 15.

A vibrating/power energy harvester may have foam spacers 20 and 21 for adjusting attraction forces of the magnetic bodies 1 and 2 and the I-shaped magnetic core 10. The foam spacers 20 and 21 prevent the I-shaped magnetic core 10 from sticking to both magnetic bodies 1 and 2 provided on the U-shaped magnetic core 15.

The coil member 30 surrounding the U-shaped magnetic core 15 forms a port connected to a circuit (e.g., a rectifier) (not shown) that manages electric energy.

The number of turns of the coil member 30 may be optimally set, considering applications in which the energy harvester is used and an impedance of an output stage of the energy harvester.

A magnetic flux 50 generated by the magnetic bodies 1 and 2 flows concentrically in the two magnetic cores 10 and 15 while being guided by the I-shaped magnetic core 10 and the U-shaped magnetic core 15.

The energy harvester may be attached to an object vibrating at a predetermined frequency, and the I-shaped magnetic core 10 may have a structure capable of vibrating at the same frequency as that of the vibrating object. To this end, the vibration/power energy harvester may be connected to a fixing arm, such as a stainless steel cantilever, so that the I-shaped magnetic core 10 may freely vibrate within a predetermined area.

In this structure, as the I-shaped magnetic core 10 vibrates at a predetermined frequency in a predetermined direction, the distance between the I-shaped magnetic core 10 and the U-shaped magnetic core 15 changes with a certain period. Thus, when the distance between the I-shaped magnetic core 10 and the U-shaped magnetic core 15 is changed, reluctance of the magnetic flux 50 flowing through the I-shaped magnetic core 10 and the U-shaped magnetic core 15 is changed. A magnitude of the magnetic flux 50 passing through the coil member 30 is also changed due to a change in the reluctance of the magnetic flux 50.

That is, as an amount of magnetic flux passing through the coil member 30 changes over time by the I-shaped magnetic core 10 which performs a vertical oscillation motion, a current flows in an output terminal of the coil member 30, whereby a voltage occurs. This phenomenon is based on Faraday's Law and Lenz's Law.

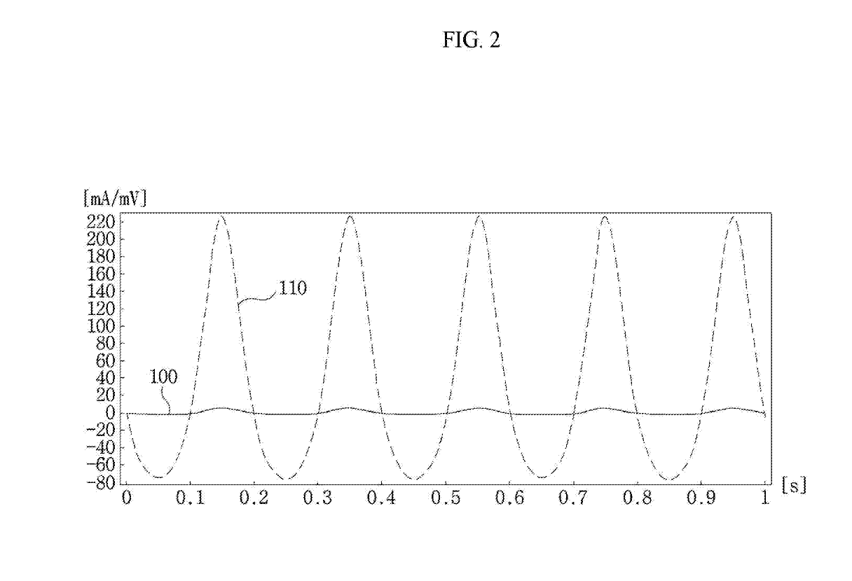

FIG. 2 is a diagram illustrating characteristics of a voltage 100 and a current 110 output from the coil member 30 provided in the energy harvester of FIG. 1.

In FIG. 2, the voltage 100 and current 110 characteristic diagram shows output characteristics when assuming that the I-shaped magnetic core 10 is oscillating at an amplitude of +/−5 [mm] and a frequency of 5 [Hz]. As can be shown in FIG. 2, a magnitude of the magnetic flux 50 flowing through the I-shaped magnetic core 10 and the U-shaped magnetic core 15 periodically varies with vertical motions of the vibrating I-shaped magnetic core 10, and correspondingly characteristics of the voltage 100 and the current 110 induced in the coil member 30 based on the magnetic flux are shifted in a positive (+) direction.

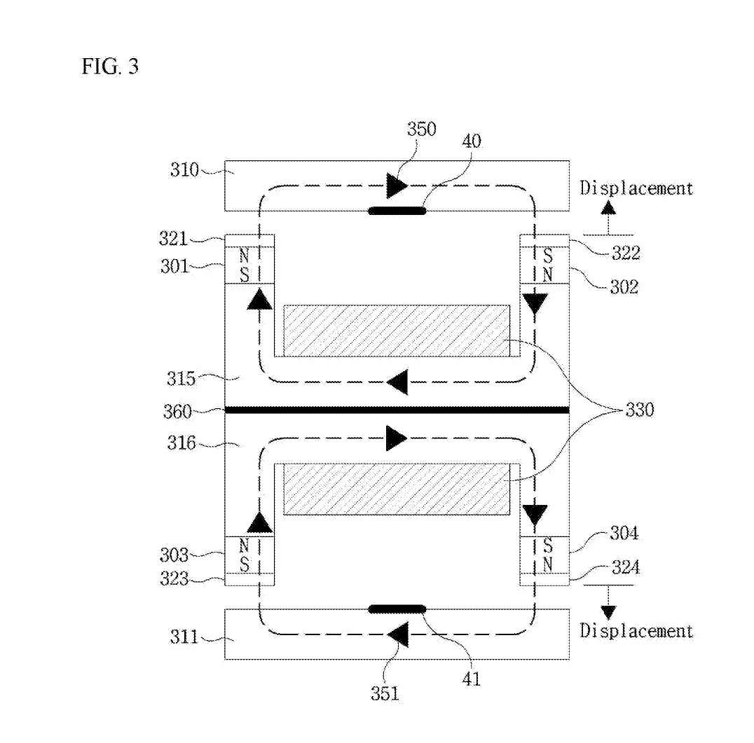

FIG. 3 is a diagram illustrating a configuration of an energy harvester according to another embodiment of the present disclosure.

The energy harvester of FIG. 3 has a structure in which two energy harvesters illustrated in FIG. 1 are symmetrically provided.

The energy harvester may include two pairs of magnetic bodies 301, 302, 303, and 304 having N and S poles, a pair of I-shaped magnetic cores 310 and 311, a pair of U-shaped magnetic cores 315 and 316, a coil member 330 surrounding the pair of U-shaped magnetic cores 315 and 316, and form spacers 321, 322, 323, and 324 for adjusting an attraction force between two pairs of magnetic bodies 301, 302, 303, and 304 and the pair of I-shaped magnetic cores 310 and 311.

Specifically, the magnetic bodies may include first, second, third, and fourth magnetic bodies 301, 302, 303, and 304, and the U-shaped magnetic cores may include first and second U-shaped cores 315 and 316, and the I-shaped magnetic cores may include first and second I-shaped cores 310 and 311, foam spacers may include first, second, third, and fourth spacers 321, 322, 323, and 324.

Opposite ends of the first U-shaped core 315 may be provided to face the first I-shaped core 310 that is longitudinally disposed, and the first and second magnetic bodies 301 and 302 may be coupled to opposite ends of the first U-shaped core 315 respectively. The first and the second spacers 321 and 322 may be coupled between the first and second magnetic bodies 301 and 302 and the first I-shaped core 310. Also, the first and second magnetic bodies 301 and 302 may be provided so that respective polarities are directed in directions different from each other. With such a structure, a magnetic flux is guided by the first I-shaped core 310 and the first U-shaped core 315 thereby causing a magnetic flux 350 in a first direction.

In the same manner-, opposite ends of the second U-shaped core 316 may be provided to facet the second I-shaped core 311 disposed longitudinally, and the third and the fourth magnetic bodies 303 and 304 may be coupled to opposite ends of the second U-shaped core 316 respectively. The third and the fourth spacers 323 and 324 may be coupled between the third and fourth the magnetic bodies 303 and 304 and the second I-shaped core 311. In addition, the third and fourth magnetic bodies 303 and 304 may be provided so that respective polarities are directed in directions different from each other. With such a structure, a magnetic flux is guided by the second I-shaped core 311 and the second U-shaped core 316, thereby causing a magnetic flux 351 in the second direction.

In addition, the first U-shaped core 315, the first I-shaped core 310, the first magnetic body 301, the second magnetic body 302, the second U-shaped core 316, a second I-shaped core 311, a third magnetic body 303, and a fourth magnetic body 304 may be disposed so that the magnetic flux 350 in the first direction and the magnetic flux 351 in the second direction are formed in directions opposite to each other. For example, bottoms of the first U-shaped core 315 and the second U-shaped core 316 are disposed in directions facing each other, and openings provided in the first U-shaped core 315 and the second U-shaped core 316 may ^{be} provided to face directions opposite to each other. In addition, the first I-shaped core 310 and the second I-shaped core 311 may be disposed in the directions in which the openings of the first U-shaped core 315 and the second U-shaped core 316 are formed respectively.

Furthermore, the energy harvester may further include a magnetic flux separation plate >360 between the first U-shaped core 315 arid the second U-shaped core 316 so that the magnetic flux 350 in the first direction and the magnetic flux 351 in the second direction can be separated from each other.

In addition, the energy harvester may further include a coil member 330 that is wound on the first U-shaped core 315 and the second U-shaped core 316 to derive currents based on changes in the magnetic flux 350 in the first direction and the magnetic flux 351 in the second direction. At this time, the number of turns of the coil member 330 can be optimally set considering applications in which the energy harvester is used and an impedance of an output stage of the energy harvester.

Preferably, the coil member 330 may be provided in a region where the first U-shaped core 315 and the second U-shaped core 316 are coupled to each other.

The first I-shaped core 310 and the second I-shaped core 311 may be provided to vibrate periodically in a predetermined direction, for example, vertical direction simultaneously. For this, the first I-shaped core 310 and the second I-shaped core 311 may be connected to a first fixing arm 340 and a second fixing arm 341 having respective predefined elastic modulus respectively. The first fixing arm 340 and the second fixing arm 341 may have the same elastic modulus. Further, the first fixing arm 340 and the second fixing arm 341 may be made of stainless steel cantilevers.

The energy harvester according to an embodiment of the present disclosure may be attached to an object vibrating at a specific frequency. As the vibration of the object is transmitted to the first fixing arm 340 and the second fixing arm 341 having a predefined elasticity, the first I-shaped core 310 and the second I-shaped core 311 are vibrated corresponding to a vibration frequency of the object.

When the I-shaped cores 310 and 311 are vibrated in a predetermined direction, the distances between the I-shaped cores 310 and 311 and the U-shaped cores 315 and 316 are changed in the same phase with a certain period. Thus, when the distances between the I-shaped cores 310 and 311 and the U-shaped cores 315 and 316 are changed in the same phase, reluctance of the magnetic flux flowing through the I-shaped cores 310 and 311 and the U-shaped cores 315 and 316 is changed. When the reluctance of the magnetic flux 350 and 351 is changed, a magnitude and a direction of the total magnetic flux passing through the region where the coil member 30 is provided are changed.

More specifically, the first periodic core 310 and the first U-shaped core 315 are brought closer to each other by the external periodic vibration, whereas the distance between the second I-shaped core 311 and the second the U-shaped core 316 is increased. Conversely, as the distance between the first straight core 310 and the first U-shaped core 315 is increased, the distance between the second I-shaped core 311 and the second U-shaped core 316 becomes closer.

This means that when the reluctance of the first magnetic flux 350 formed between the first I-shaped core 310 and the first U-shaped core 315 becomes small, the reluctance of the second magnetic flux 351 formed between the second I-shaped core 311 and the second U-shaped core 316 is increased. That is, when a magnitude of the first magnetic flux 350 increases, a magnitude of the second magnetic flux 351 decreases, whereas when a magnitude of the first magnetic flux 350 decreases, a magnitude of the second magnetic flux 351 increases.

In addition, the first magnetic flux 350 generated by the first and second magnetic bodies 301 and 302 is formed in a direction opposite to the second magnetic flux 351 generated by the third and fourth magnetic bodies 303 and 304. Since a current induced by the first magnetic flux 350 and a current induced by the second magnetic flux 351 increase and decrease inversely proportional to each other, the total electric energy induced in the coil member 330 may exhibit the same value.

As such, the energy harvester according to an embodiment of the present disclosure can maximize a gradient of the magnetic flux in the same vibration environment because a magnitude and a direction of the magnetic flux passing through a cross section of the coil member 30 are changed, thereby creating the effect of increasing the energy conversion efficiency.

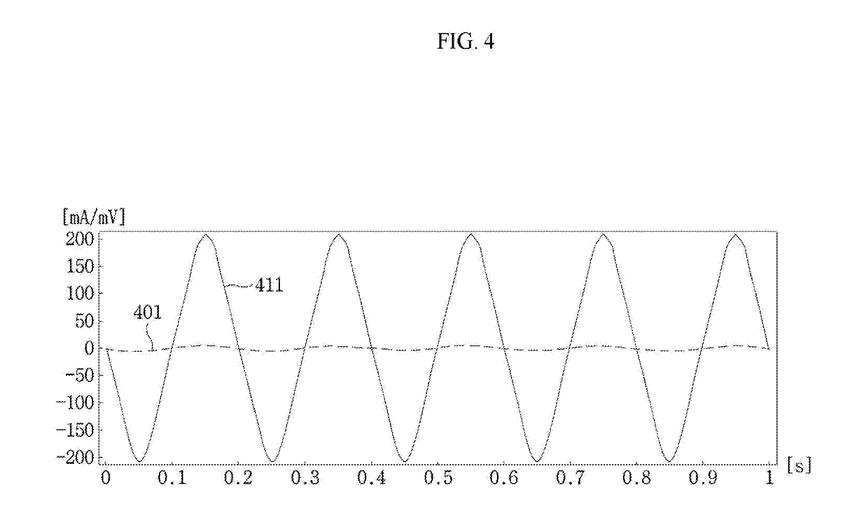

FIG. 4 is a diagram illustrating characteristics of a voltage and a current induced in a coil member included in the energy harvester of FIG. 3.

FIG. 4 illustrates a case where the first I-shaped core 310 and the second I-shaped core 311 provided in FIG. 3 vibrate at an amplitude of +/−5 [mm] and a frequency of 5 [Hz].

Referring to FIG. 4, since a magnitude and a direction of total magnetic flux passing through the coil member 330 change simultaneously due to vertical motions of the vibrating first I-shaped core 310 and the vibrating second I-shaped core 311, a characteristic curve of the voltage 401 and the current 411 is formed symmetrically with respect to the reference point 0 and amplitudes of the voltage 401 and the current 411 may be formed to be relatively large.

Thus, the energy harvester according to an embodiment of the present disclosure maximizes a gradient of the magnetic flux passing through the coil member in a vibration environment of the same acceleration, thereby realizing high-efficiency energy conversion.

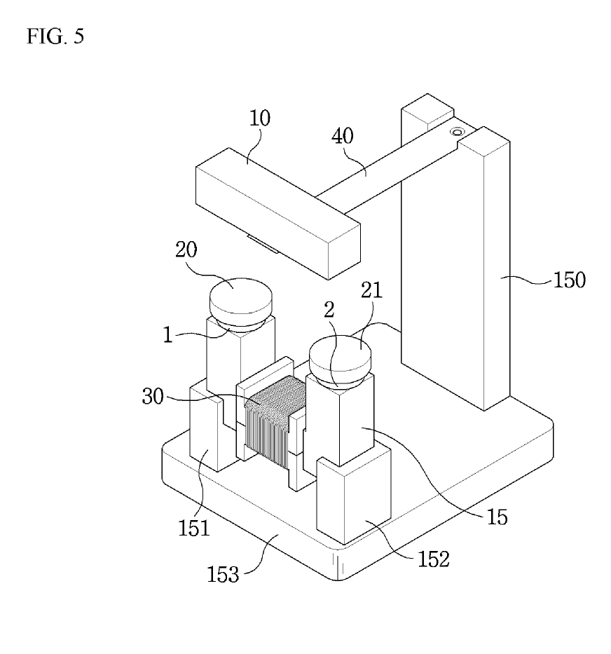

FIG. 5 is a diagram illustrating a configuration of an energy harvester according to an embodiment of the present disclosure.

The energy harvester according to an embodiment of the present disclosure disclosed in FIG. 5 includes the structure of the energy harvester described above with reference to FIG. 1.

The energy harvester according to an embodiment of the present disclosure may include the I-shaped magnetic core 10, the U-shaped magnetic core 15, the pair of magnetic bodies 1 and 2, the foam spacers 20 and 21, the coil member 30, fixing arms 40 and 150, fixing members 151 and 152, and a base plate 153.

The I-shaped magnetic core 10, the U-shaped magnetic core 15, the pair of magnetic bodies 1 and 2, the foam spacers 20 and 21, and the coil member 30 are provided such that the I-shaped magnetic core 10 and the U-shaped magnetic core 15 may be provided to cause magnetic flux formed by the magnetic bodies 1 and 2 to be concentrated as shown in FIG. 1, and the coil member 30 may output an induced current based on the magnetic flux formed in the U-shaped magnetic core 15.

In addition, the energy harvester may be attached to or coupled to an object vibrating at a predetermined cycle. The I-shaped magnetic core 10 may have a structure capable of vibrating at a predetermined cycle in response to movements of the object. In particular, the energy harvester may have a base plate 153 of a structure that may be attached or coupled to the object. The fixing members 151 and 152 may be coupled to the base plate 153 and the U-shaped magnetic core 15, and an opening formed in the U-shaped magnetic core 15 is provided to face a direction in which the I-shaped magnetic core 10 is provided.

The fixing arms 40 and 150 may include a fixing support 150 of which at least a part is coupled to and fixed to the base plate 153 and an elastic arm 40 having one end thereof attached or coupled to the fixing support 150 and the other end attached or coupled to the I-shaped magnetic core 10. The elastic arm 40 may be made of a material having a predetermined elastic modulus. As the base plate 153 moves or vibrates in a predetermined direction, the I-shaped magnetic core 10 is provided to move corresponding to a magnitude and a direction in which the base plate 153 moves or vibrates.

The elastic arm 40 may be made of stainless cantilever materials.

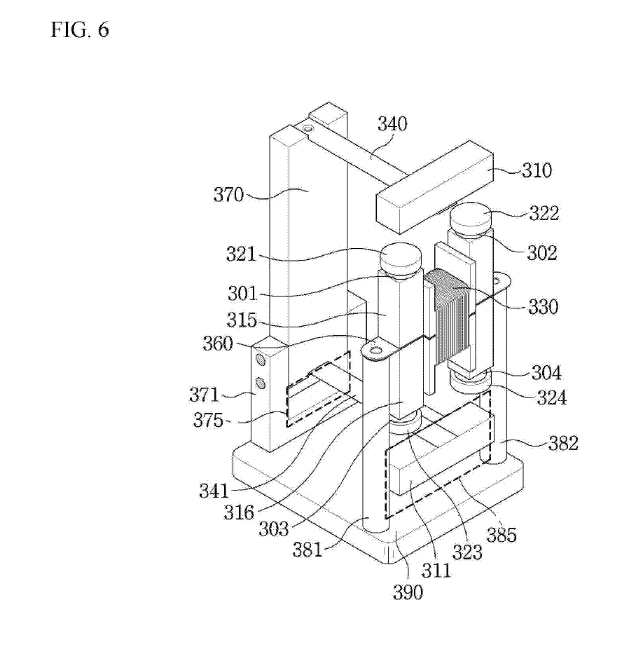

FIG. 6 is a diagram illustrating a configuration of an energy harvester according to another embodiment of the present disclosure.

The energy harvester according to another embodiment of the present disclosure disclosed in FIG. 6 includes the structure of the energy harvester described above with reference to FIG. 3.

The energy harvester according to another embodiment of the present disclosure may include: two pairs of magnetic bodies, namely, first, second, third, and fourth magnetic bodies 301, 302, 303, and 304; a pair of I-shaped magnetic cores, namely, first and second I-shaped cores 310 and 311; a pair of U-shaped magnetic cores, namely, first and second U-shaped cores 315 and 316; a coil member 330; foam spacers, namely, first, second, third, and fourth spacers 321, 322, 323, and 324; and a magnetic flux separation plate 360, as shown in FIG. 3.

Such components is provided as shown in FIG. 3 such that the pair of I-shaped magnetic cores, namely, the first and the second I-shaped cores 310 and 311 and the pair of U-shaped magnetic cores, namely, the first and the second U-shaped cores 315 and 316 may be provided to allow magnetic fluxes 350 and 351 formed by the magnetic bodies, namely, the first, the second, the third, and the fourth magnetic bodies 301, 302, 303, and 304—to be concentrated, and the coil member 330 may output an induced current based on the magnetic flux 350 and 351 formed by the U-shaped magnetic cores, that is, the first and the second U-shaped cores 315 and 316.

In addition, the energy harvester according to another embodiment of the present disclosure is provided such that it may be attached or coupled to an object vibrating at a predetermined cycle to allow the I-shaped magnetic cores 310 and 311 to vibrate at a predetermined cycle corresponding to movements of the object. To this end, the energy harvester includes fixing arms 340, 341, 370, and 371 for fixing the pair of I-shaped magnetic cores, that is, the first and the second I-shaped cores 310 and 311 and fixing members 381 and 382 for fixing the pair of U-shaped magnetic cores, that is, the first and second U-shaped cores 315 and 316, and also includes a base plate 390 for fixing the fixing arms 340, 341, 370, and 371 and the fixing members 381 and 382.

The base plate 390 may be provided to be attached or coupled to the object.

The fixing members 381 and 382 has one end fixed to the base plate 390 and the other end coupled and fixed to a pair of U-shaped magnetic cores, that is, the first and the second U-shaped cores 315 and 316.

According to another embodiment of the present disclosure, the energy harvester is provided such that the pair of I-shaped magnetic cores, that is, the first and the second I-shaped cores 310 and 311 move and vibrate in a partial area in directions of openings formed in the pair of U-shaped magnetic cores, that is, the first and second U-shaped cores 315 and 316. In particular, the second I-shaped core 311 may be provided to move or vibrate in a predetermined area 385 between an end of the second U-shaped core 316 and the base plate 390. Thus, the fixing members 381 and 382 may hold the pair of U-shaped magnetic core, that is, the first and the second U-shaped cores 315 and 316 so that the predetermined area 385 is formed between the end of the second U-shaped core 316 and the base plate 390.

In addition, the energy harvester may be attached or coupled to an object that vibrates at a given cycle, and the pair of I-shaped magnetic cores, that is, the first and the second-shaped cores 310 and 311 may be provided to vibrate at a given cycle corresponding to movements of the object

In particular, the fixing arms 340, 341, 370, and 371 may be provided to support movements or vibrations of the pair of I-shaped magnetic cores, that is, the first and the second I-shaped cores 310 and 311. Specifically, the fixing arms 340, 341, 370, and 371 include the fixing supports 370 and 371 of which at least a part is attached and coupled to the base plate 390 and the elastic arms 340 and 341 having respective one ends attached or coupled to the fixing supports 370 and 371 and respective other ends coupled to the first and the second I-shaped magnetic cores 310 and 311, respectively.

That is, the first elastic arms 340 have one area fixed to the fixing supports 370 and 371 and the other area connected to the first I-shaped core 310 to support movements or vibrations of the first I-shaped core 310. The second elastic arm 341 has one area fixed to the fixing supports 370 and 371 and the other area connected to the second I-shaped core 311 to support movements or vibrations of the second I-shaped core 311. At this time, the second I-shaped core 311 must move or oscillate within the predetermined area 385 provided between the end of the second U-shaped core 316 and the base plate 390. Thus, one area of the second elastic arm 341 may be fixed to the fixing supports 370 and 371, in which the second elastic arm 341 may be fixed to be spaced a predetermined distance from the base plate 390 to support the movements of the second I-shaped core 311.

Further, the first fixing support 370 and the second fixing support 371 may be provided such that one area of the second elastic arm 341 may be spaced a predetermined distance from the base plate 390 and fixed to the fixing supports 370 and 371. The second fixing support 371 is fixed to the base plate 390 and may be coupled to the first fixing support 370. The second fixing support 371 may be provided such that a bottom surface thereof is fixed to the base plate 390 and provided to have a U-shape having opposite side walls. The first fixing support 370 is coupled to opposite side walls of the second fixing support 371 so that a predefined space 375 is formed between an upper surface of the second fixing support 371 and a lower surface of the first fixing support 370. The second elastic arm 341 may be coupled to the lower surface of the first fixing support 370 thereby moving in the predetermined space 375.

Although the exemplary methods of this disclosure are represented by a series of steps for clarity of explanation, they are not intended to limit the order in which the steps are performed, and if necessary, each step may be performed simultaneously or in a different order. In order to implement the method according to the present disclosure, it is possible to include other steps to the illustrative steps additionally, exclude some steps and include remaining steps, or exclude some steps and include additional steps.

The various embodiments of the disclosure are not intended to be exhaustive of all possible combination, but rather to illustrate representative aspects of the disclosure, and the features described in the various embodiments may be applied independently or in a combination of two or more.

What is claimed is:

1. An energy harvester comprising:
a first core and a second core vibrating in a predetermined direction within areas different from each other;
a third core being U-shaped and having opposite ends facing at least a part of the first core;
a fourth core being U-shaped and having a bottom thereof contacting a bottom of the third core and opposite ends facing at least a part of the second core;
a pair of first magnetic bodies forming a magnetic flux connected between the first core and the third core;
a pair of second magnetic bodies forming a magnetic flux connected between the second core and the fourth core; and
a coil member wound on the third core and the fourth core to generate an induced current due to a magnetic flux change in the third core and the fourth core.

2. The energy harvester of claim 1, wherein the magnetic flux between the first core and the third core and the magnetic flux between the second core and the fourth core are formed in directions different from each other.

3. The energy harvester of claim 1, wherein the pair of the first magnetic bodies are provided in opposite ends of the third core.

4. The energy harvester of claim 3, wherein the pair of the second magnetic bodies are provided in opposite ends of the fourth core.

5. The energy harvester of claim 1, further comprising a plurality of spacers provided in respective ends of the pair of first magnetic bodies and the pair of second magnetic bodies.

6. The energy harvester of claim 1, wherein the pair of first magnetic bodies have polarities in directions different from each other, and the pair of second magnetic bodies have polarities in directions different from each other.

7. The energy harvester of claim 1, further comprising a first fixing arm guiding the first core to vibrate in the predetermined direction within a first predetermined area and a second fixing arm guiding the second core to vibrate in the predetermined direction within a second predetermined area.

8. The energy harvester of claim 7, further comprising a fixing member fixing the third core and the fourth core.

9. The energy harvester of claim 1, wherein an opening of the third core is directed into a first predetermined area and an opening of the fourth core is directed into a second predetermined area.

10. The energy harvester of claim 8, further comprising a base plate on which the first fixing arm, the second fixing arm, and the fixing member are mounted, wherein the first core and the second core vibrate in the predetermined direction as the base plate vibrates in the predetermined direction.

11. The energy harvester of claim 1, further comprising a rectifier rectifying and outputting a current provided from the coil member.

12. The energy harvester of claim 7, wherein the first fixing arm and the second fixing arm include stainless cantilevers.

13. The energy harvester of claim 1, further comprising a metal plate provided between the third core and the fourth core to separate a magnetic flux connected between the first core and the third core from a magnetic flux connected between the second core and the fourth core.

14. An energy harvester comprising:
a first core vibrating in a predetermined direction;
a second core being U-shaped and having opposite ends facing at least a part of the first core;
a pair of magnetic bodies forming a magnetic flux connected between the first core and the second core; and
a coil member wound on the second core to generate an induced current due to a magnetic flux change in the second core.

15. The energy harvester of claim 14, further comprising a plurality of spacers provided in ends of the pair of magnetic bodies, respectively.

16. The energy harvester of claim 14, wherein the pair of magnetic bodies have polarities in directions different from each other.

17. The energy harvester of claim 14, further comprising a fixing arm guiding the first core to vibrate in the predetermined direction within a predetermined area.

18. The energy harvester of claim 17, further comprising a fixing member fixing the second core.

19. The energy harvester of claim 17, wherein an opening of the second core is directed into the predetermined area.

20. The energy harvester of claim 18, further comprising a base plate on which the fixing arm and the fixing member are mounted, wherein the first core vibrates in the predetermined direction as the base plate vibrates in the predetermined direction.
